(19) United States
(12) Patent Application Publication
(10) Pub. No.: US 2004/0202989 A1
(43) Pub. Date: Oct. 14, 2004

(54) Eyewear with scriptures

(76) Inventors: Sherry L. Thompson, Memphis, TN (US); Janice L. Dumas, Memphis, TN (US)

Correspondence Address: LITMAN LAW OFFICES, LTD., P.O. BOX 15035 CRYSTAL CITY STATION, ARLINGTON, VA, 22215, US

(21) Appl. No.: 10/410,260

(22) Filed: Apr. 10, 2003

(51) Int. Cl. G09B 19/00

(52) U.S. Cl. 434/245

(57) ABSTRACT

A biblical scripture teaching device comprising eyewear glasses equipped with a scripture display means. The eyewear glasses have a front frame portion and a pair of temple portions secured to either side of the front frame portion. The scripture display means is disposed on either the interior or exterior surface of the temple portion. The scripture display means comprises full or partial text of biblical scriptures that are engraved or printed onto the temple portions of the eyewear. The scriptures displayed on the eyewear promote teaching and communication of biblical scriptures.

### BACKGROUND OF THE INVENTION

1. Field of the Invention

The present invention relates to biblical scripture teaching devices and, more particularly, to eyewear glasses with a means for displaying a biblical scripture or inspirational religious message to promote teaching and communication of biblical scriptures.

2. Description of the Related Art

People commonly attend bible reading groups or other religious classes to further their understanding of the Bible and their religion. While it is easy to promote religious discussion in structured settings such as reading groups and classes, it is often difficult to engage others in religious conversation during the course of normal daily routine. It is often inconvenient to carry a Bible or other book of scriptures around wherever you go. Also, reading from the bible is not an appealing form of religious education for some people. It is often desirable to have a more convenient form of teaching aid to promote a religious conversation.

Religion and the teachings of the bible are not just valued for educational purposes. Many people find comfort in the words of the bible during emotionally distressed times. It is often desirable to have a particularly comforting passage from the scriptures or other inspiration message easily available.

The inventions in the following patent documents provide examples of devices for displaying and teaching biblical scriptures.

U.S. Pat. No. 3,936,384 to Williams discloses a soap bar that is embossed with a religious design on one side and a prayer on the other side. The top side of the bar has the markings of a crucifixion scene. The bottom side of the bar displays the Lord's Prayer.

U.S. Pat. No. 4,493,652 to Mike discloses an inspirational teaching apparatus. The apparatus contains a button that is pressed by the user. Once the users presses the button shutters on the front of the apparatus pivot open. A visual depiction of an ever-growing inspirational symbol commences. This gives an appearance that the symbol is moving toward the user. When the symbol reaches its maximum size, the words to an inspirational message are illuminated below the symbol. A sound track is activated to read the inspirational message to the user. The user then presses a button to hear a new message.

U.S. Pat. No. 6,059,291 to Gary discloses a method of playing a learning enhanced card game. The card game comprises four or more suits of cards. The cards have information relating to religious studies, in particular the Christian Bible where each suit is topically related to each other such as the topics of peace, love, faith, commandments, evil, happiness, prayer and hope.

U.S. Pat. No. 6,322,369 to Patterson et al. discloses a Christian learning tool. The learning tool is an educational toy in the shape of an open Bible. The top surface of the toy is divided into two portions. A first portion has a cradle for receiving a pair of praying hands that are attached to the toy by a tether. The first portion also has a speaker. The second portion contains a plurality of buttons, which each, when pressed, select a different educational topic.

U.S. Pat. No. 6,447,363 to Carraway discloses a method of conveying an intercessory prayer pledge. The method includes writing prayers or inspirational messages on a fabric doll with a pen that is attached to the doll. The doll is then taken to the intended person to comfort the person.

None of the above patents disclose inventions that provide a convenient means for displaying religious scriptures or inspirational messages to promote education and communication of biblical scriptures during a user's normal daily routine. What is needed is a device for providing a user with a convenient way to carry and display biblical quotes in order to promote religious communication with others.

None of the above inventions and patents, taken either singularly or in combination, is seen to describe the instant invention as claimed. Thus eyewear with scriptures solving the aforementioned problems is desired.

### SUMMARY OF THE INVENTION

The present invention is a biblical scripture teaching device comprising eyewear glasses having a biblical scripture display means. The eyewear glasses comprise a front frame portion and a pair of temple portions secured to either side of said front frame portion. The scripture display means is disposed on an interior or exterior surface of the temple portions. The scriptures displayed on said eyewear promote the teaching and communication of biblical scriptures and other inspirational messages.

Accordingly, it is a principal object of the invention to provide a convenient means for carrying and displaying religious scriptures and other inspirational messages.

It is another object of the invention to provide a device that promotes the teaching and communication of religious scriptures during normal daily routine.

It is a further object of the invention to provide a device that provides the user with convenient access to comforting and inspirational messages at anytime.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of eyewear with scriptures according to the present invention.

FIG. 2 is a perspective view of a first embodiment of the eyewear with scriptures.

FIG. 3 is a perspective view of a second embodiment of the eyewear with scriptures.

Similar reference characters denote corresponding features consistently throughout the attached drawings.

### DETAILED DESCRIPTION OF THE PREFERRED EMBODIMENTS

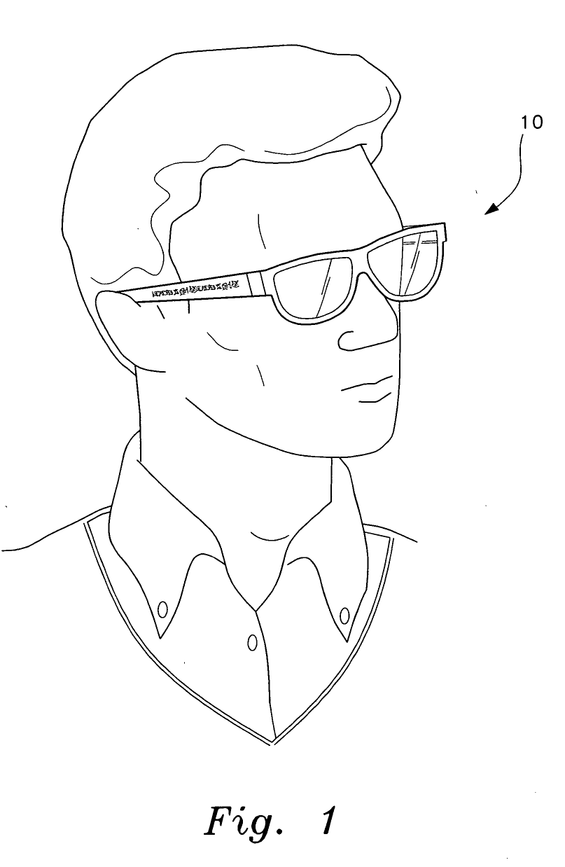

The present invention is a biblical scripture teaching device comprising eyewear glasses having a biblical scripture display means. The eyewear glasses display a biblical scripture or other inspirational message. FIG. 1 depicts an environmental, perspective view of the eyewear with scriptures 10 according to the present invention. The eyewear 10 provides the user with a convenient way to promote religious communication by displaying a religious message. The eyewear 10 also provides comfort to the user of the device by making the scripture or other inspirational message readily available to the user.

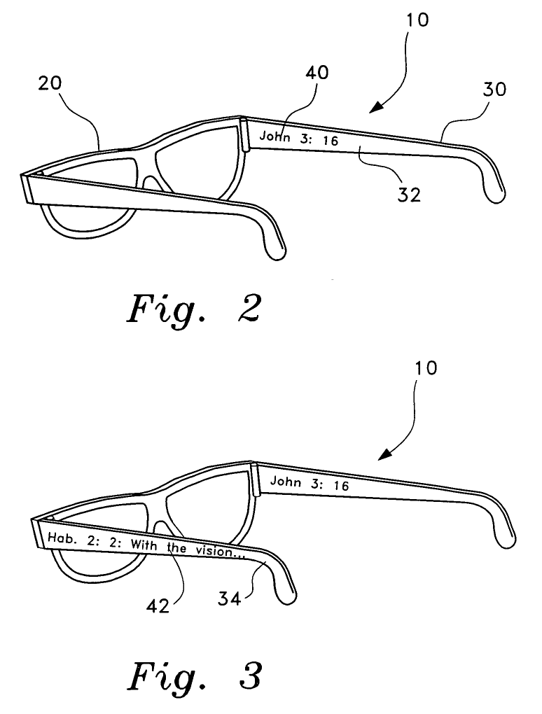

FIG. 2 displays a perspective view of a first embodiment of the eyewear with scriptures 10. The eyewear comprises a front frame portion 20. The front frame portion 20 rests on the user's face and contains the lenses of the eyewear. The eyewear 10 further comprises a pair of temple portions 30 pivotally attached to either side of the front frame portion 20. A scripture display means 40 is disposed on the interior surface 32 of each of the temple portions 30. The scripture display means 40 is disposed on the temple portions by either printing or engraving. The scripture display means 40 displays either the text of a religious scripture or an inspirational message.

FIG. 3 depicts a perspective view of a second embodiment of the eyewear with scriptures 10. The second embodiment includes generally the same features as the first embodiment. In addition, the second embodiment comprises a second scripture display means 42 disposed on the exterior surface 34 of each temple portion 30. The scripture display means 42 may be disposed on either the interior 32 or exterior 34 surface of either temple portion 30. The scripture display means may be used on any combination of surfaces as well.

In use, an owner of the eyewear with scriptures 10 will wear the device and display the text of a biblical scripture or inspirational message. If the user is emotionally distressed or otherwise in need of comforting, the user simply removes the glasses to read the scripture or inspirational message. Also, the eyewear with scriptures can promote communication and teaching of biblical scriptures with others by displaying the message on the exterior of the eyewear.

The present invention may be used with any form of eyewear including, but not limited to, reading glasses, sunglasses, swimming goggles, safety glasses and prescription eyewear. The scriptures displayed on the eyewear can be selected from any book, chapter or verse of the Bible. Also, the scriptures may be selected from any version of the Bible. Finally, the scriptures may be printed in any language including, but not limited to English, Spanish and French.

It is to be understood that the present invention is not limited to the embodiments described above, but encompasses any and all embodiments within the scope of the following claims.

1-5 (Canceled)

6. A biblical scripture teaching device comprising:
eyewear glasses including a front frame having opposite ends, a first temple member extending from one of said opposite ends of said front frame, and a second temple member extending from the other one of said opposite ends of said front frame;
said first temple member having first and second display portions integrally formed therein;
said second temple member having third and fourth display portions integrally formed therein; and
at least one of said first, second, third, and fourth display portions having indicia permanently disposed thereon;
wherein said indicia is selected from the group consisting essentially of a scripture reference, a scripture text, a scripture reference and scripture text combined, and an inspirational message;
whereby teaching and communication of biblical scriptures is promoted by said scriptures being displayed on said eyewear.

7. The biblical scripture teaching device according to claim 6, wherein said permanently disposed indicia is printed on at least one of said first, second, third, and fourth display portions.

8. The biblical scripture teaching device according to claim 6, wherein said permanently disposed indicia is engraved upon at least one of said first, second, third, and fourth display portions.
